(19) United States
(12) Patent Application Publication
(10) Pub. No.: US 2008/0230479 A1
(43) Pub. Date: Sep. 25, 2008

(54) LIQUID CHROMATOGRAPH CONTROL APPARATUS AND METHOD

(75) Inventors: Keigo Suzuki, Shiga (JP); Keisuke Abe, Kanagawa (JP)

Correspondence Address: DARBY & DARBY P.C., P.O. BOX 770, Church Street Station, New York, NY, 10008-0770, US

(73) Assignee: MORITEX CORPORATION, Tokyo (JP)

(21) Appl. No.: 12/052,586

(22) Filed: Mar. 20, 2008

(30) Foreign Application Priority Data
Mar. 20, 2007 (JP) 2007-73475

(51) Int. Cl. B01D 21/34; B01D 15/08

(52) U.S. Cl. 210/658; 210/101

(57) ABSTRACT

A liquid chromatograph control apparatus for controlling the solvent mixing ratios of liquid chromatography, comprising a storage means for storing the correspondence relationship between the plural discrete Rf values obtained by thin layer chromatography performed on respective samples at a preset solvent mixing ratio and the appropriate sequences of solvent mixing ratios of liquid chromatography for the respective samples; an arithmetic means for obtaining, by interpolation, the appropriate sequence of solvent mixing ratios corresponding to any Rf value falling between the stored Rf values adjacent to each other; and an image processing means for imaging the thin layer plates obtained by performing thin layer chromatography, to obtain Rf values from the images.

### INCORPORATION BY REFERENCE

The present application claims priority under 35 U.S.C. §119 to Japanese Patent Application No. 2007-73475, filed Mar. 20, 2007. The content of the application is incorporated herein by reference in its entirety.

### FIELD OF THE INVENTION

The present invention relates to a liquid chromatograph control apparatus and method.

### BACKGROUND OF THE INVENTION

Thin layer chromatography and liquid chromatography are different from each other in the constitution and shape of the instrument, solvent feed method, etc., but are essentially identical with each other in the principle that a sample mixture is moved for being separated into its respective components. So, it is known that there is correlativity between the retardation factor of a sample in thin layer chromatography and the elution time of the sample in liquid chromatography in the case where the same stationary phase is used. That is, in general, if the Rf (retardation factor) value of thin layer chromatography is larger, the elution time in liquid chromatography tends to be shorter.

So, attempts are being made to effectively use the result obtained by performing highly simple and rapid thin layer chromatography for performing liquid chromatography.

For example, JP2001-124755A describes a method for deciding a protocol, comprising the steps of

a) selecting a library of compounds to be purified,
b) performing a TLC and/or an analytical HPLC on a representative sample of the library, which sample comprises less than ten percent of the library,
c) determining a correlated preparative HPLC method depending on how the representative sample elutes off the analytical HPLC column and/or the sample moves on a TLC plate, and
d) purifying all or substantially all of the library,
wherein the correlated preparative HPLC method is determined based on a correlation between three or more zones of retention times if analytical HPLC is performed and/or three or more zones of retention factors if TLC is performed, such that if substantially all of the compounds in the representative sample fall within a particular zone, a correlated preparative HPLC protocol can be used to purify compounds that fall within the zone.

Further, JP3423707B1 describes a liquid chromatograph control apparatus comprising: a measured value storage that stores a measured retardation factor (Rf) value of a sample, which is obtained when components of the sample are separated on thin layer chromatography using an eluent containing a plurality of ingredients at a specified mixture ratio, in association with the specified mixture ratio, a rate-of-change-in-Rf-value storage that stores a rate of change in the retardation factor (Rf) value of the sample with respect to variation in mixture ratio of ingredients of the eluent, a mixture ratio calculator that determines a mixture ratio of the eluent at which a specified retardation factor value (Rf_{O}) of the sample is obtained, based on the measured retardation factor (Rf) value corresponding to the specified mixture ratio stored in the measured value storage and on the rate of change in the retardation factor (Rf) value stored in the rate-of-change-in-Rf-value storage, and a mixture ratio controller that outputs a control signal to control the mixture ratio of the eluent fed into a column so that the retardation factor (Rf) value of the sample can be equivalent to the specified retardation factor value (Rf_{O}), based on calculated results by the mixture ratio calculator.

The samples to be separated or analyzed by using liquid chromatography include a wide variety of organic compounds in general. So, according to the method described in JP3423707B1 for obtaining the mixture ratio of an eluent at which a specified retardation factor value is obtained using a retardation factor Rf and the rate of change in the retardation factor, it is not always possible to obtain the rate of change in Rf value corresponding to the Rf value obtained as a result of performing thin layer chromatography, and it is difficult to obtain all-inclusive measured data.

Further, in the method described in JP2001-124755A, the liquid chromatography performing condition is decided zone by zone. So, the performing condition is not always appropriate for a sample having continuous Rf values obtained by thin layer chromatography.

### SUMMARY OF THE INVENTION

The present invention has been created in view of the above-mentioned problems of the prior art. The object of this invention is to provide a liquid chromatograph control apparatus and method for allowing liquid chromatography to be performed according to a simply set appropriate sequence of solvent mixing ratios.

To achieve the aforesaid object of this invention, an embodiment proposes a liquid chromatograph control apparatus for controlling the solvent mixing ratios of liquid chromatography, comprising a storage means for storing the correspondence relationship between the plural discrete Rf values obtained by thin layer chromatography performed on respective samples at a preset solvent mixing ratio and the appropriate sequences of solvent mixing ratios of liquid chromatography for the respective samples; and an arithmetic means for obtaining, by interpolation, the appropriate sequence of solvent mixing ratios corresponding to any Rf value falling between the stored Rf values adjacent to each other.

Further in this invention, another embodiment proposes a liquid chromatograph control apparatus for controlling the solvent mixing ratios of liquid chromatography, comprising a storage means for storing the correspondence relationship between the plural discrete Rf values obtained by thin layer chromatography performed on respective samples at a preset solvent mixing ratio and the appropriate sequences of solvent mixing ratios of liquid chromatography for the respective samples; an arithmetic means for obtaining, by interpolation, the appropriate sequence of solvent mixing ratios corresponding to any Rf value falling between the stored Rf values adjacent to each other; and an image processing means for imaging the thin layer plates obtained by performing thin layer chromatography, to obtain Rf values from the images.

Further in this invention, yet another embodiment proposes a liquid chromatograph control apparatus for controlling the solvent mixing ratios of liquid chromatography, comprising a storage means for storing the correspondence relationships between the plural discrete Rf values obtained by thin layer chromatography performed on respective samples respectively containing plural components at a preset solvent mixing ratio and the appropriate sequences of solvent mixing ratios of liquid chromatography for the respective samples, with the separation degree between any two adjacent components of the plural components developed by thin layer chromatography as a parameter; a selection means for selecting a correspondence relationship stored in the storage means in reference to the separation degree between the corresponding two adjacent components of the plural components; and an arithmetic means for obtaining, by interpolation, the appropriate sequence of solvent mixing ratios corresponding to any Rf value falling between the stored Rf values adjacent to each other in the selected correspondence relationship.

Further in this invention, a further embodiment proposes a liquid chromatograph control apparatus for controlling the solvent mixing ratios of liquid chromatography, comprising a storage means for storing the correspondence relationship between the plural discrete Rf values obtained by thin layer chromatography performed on respective samples respectively containing plural components at a preset solvent mixing ratio and the appropriate sequences of solvent mixing ratios of liquid chromatography for the respective samples, and further for storing the correction factor values corresponding to the respective degrees of separation between any two adjacent components of the plural components developed by thin layer chromatography, for correcting the correspondence relationship; and an arithmetic means for correcting the correspondence relationship stored in the storage means by the correction factor value corresponding to the separation degree between the corresponding two adjacent components of the plural components and further for obtaining, by interpolation, the appropriate sequence of solvent mixing ratios corresponding to any Rf value falling between the stored Rf values adjacent to each other in the corrected correspondence relationship.

Further in this invention, an alternate embodiment proposes a liquid chromatograph control apparatus for controlling the solvent mixing ratios of liquid chromatography, comprising a storage means for storing the correspondence relationships between the plural discrete Rf values obtained by thin layer chromatography performed on respective samples respectively containing plural components at a preset solvent mixing ratio and the appropriate sequences of solvent mixing ratios of liquid chromatography for the respective samples, with the separation degree between any two adjacent components of the plural components developed by thin layer chromatography as a parameter; a selection means for selecting a correspondence relationship stored in the storage means in reference to the separation degree between the corresponding two adjacent components of the plural components; an arithmetic means for obtaining, by interpolation, the appropriate sequence of solvent mixing ratios corresponding to any Rf value falling between the stored Rf values adjacent to each other in the selected correspondence relationship; and an image processing means for imaging the thin layer plates obtained by performing thin layer chromatography, to obtain the distances between the developed plural components and Rf values from the images.

Further in this invention, an embodiment proposes that the selection means is a manual selection means for manually selecting a correspondence relationship stored in the storage means in reference to the separation degree between the corresponding two adjacent components of the plural components.

Further in this invention, another embodiment proposes that the selection means is an automatic selection means for automatically selecting a correspondence relationship stored in the storage means in reference to the separation degree between the corresponding two adjacent components of the plural components.

Further in this invention, yet another embodiment proposes a liquid chromatograph control apparatus for controlling the solvent mixing ratios of liquid chromatography, comprising a storage means for storing the correspondence relationship between the plural discrete Rf values obtained by thin layer chromatography performed on respective samples respectively containing plural components at a preset solvent mixing ratio and the appropriate sequences of solvent mixing ratios of liquid chromatography for the respective samples, and further for storing the correction factor values corresponding to the respective degrees of separation between any two adjacent components of the plural components developed by thin layer chromatography, for correcting the correspondence relationship; an arithmetic means for correcting the correspondence relationship stored in the storage means by the correction factor value corresponding to the separation degree between the corresponding two adjacent components of the plural components and further for obtaining, by interpolation, the appropriate sequence of solvent mixing ratios corresponding to any Rf value falling between the stored Rf values adjacent to each other in the corrected correspondence relationship; and an image processing means for imaging the thin layer plates obtained by performing thin layer chromatography, to obtain the distances between the plural components and Rf values from the images.

Further in this invention, a further embodiment purposes that the degree of separation is expressed with the distance between adjacent components as an indicator, with the difference between the inverse numbers of the Rf values of adjacent components as an indicator, or with the quotient of the Rf values of the substances corresponding to adjacent components as an indicator.

Further in this invention, an embodiment proposes that the correspondence relationships are obtained for respective types of columns and are stored to allow selection for each type of columns.

Further in this invention, another embodiment proposes that the correspondence relationships are obtained for respective solvents and are stored to allow selection for each solvent.

Further in this invention, an alternative embodiment proposes that each of the correspondence relationships stored in the storage means is the direct relationship between Rf values and appropriate sequences of solvent mixing ratios.

Further in this invention, yet another embodiment proposes that each of the correspondence relationships stored in the storage means is a correspondence relationship between the function values of Rf values and appropriate sequences of solvent mixing ratios. A further aspect of the invention proposes that the function values of Rf values are the inverse numbers of Rf values.

Further in this invention, yet another embodiment proposes that the appropriate sequences of solvent mixing ratios stored in the storage means are appropriate time sequences of solvent mixing ratios.

Further in this invention, yet another embodiment proposes that each of the appropriate sequences of solvent mixing ratios stored in the storage means is an appropriate sequence of the mixing ratio index values obtained with said preset solvent mixing ratio (solvent concentration) of thin layer chromatography as 1.

Further in this invention, yet another embodiment proposes a liquid chromatograph control method comprising the step of performing thin layer chromatography on respective samples at a preset solvent mixing ratio for obtaining Rf values, performing liquid chromatography for obtaining the appropriate sequences of solvent mixing ratios of liquid chromatography for the respective samples, and storing the correspondence relationship between the plural discrete Rf values obtained by thin layer chromatography performed on respective samples at a preset solvent mixing ratio and the appropriate sequences of solvent mixing ratios of liquid chromatography in a storage means; the step of performing thin layer chromatography on a desired sample to obtain an Rf value before performing liquid chromatography on the sample; the step of obtaining, by interpolation, the appropriate sequence of solvent mixing ratios corresponding to the obtained Rf value from the respective appropriate sequences of solvent mixing ratios of the Rf values on both sides of the obtained Rf value and adjacent to each other stored in the storage means; and performing liquid chromatography according to the obtained appropriate sequence of solvent mixing ratios.

Further in this invention, an embodiment proposes that the Rf values of thin layer chromatography are obtained from the images of thin layer plates obtained by an imaging means.

Further in this invention, yet another embodiment proposes liquid chromatograph control method, comprising the step of performing thin layer chromatography on the respective samples respectively containing plural components at a preset solvent mixing ratio to obtain Rf values and the degrees of separation between developed plural components, performing liquid chromatography for obtaining the appropriate sequences of solvent mixing ratios of liquid chromatography for the respective samples, for the respective degrees of separation between developed plural components, and storing the correspondence relationships between the plural discrete Rf values obtained by thin layer chromatography performed on respective samples at a preset solvent mixing ratio and the appropriate sequences of solvent mixing ratios of liquid chromatography in a storage means with the separation degree between any two adjacent components of the developed plural components as a parameter; the step of performing thin layer chromatography on a desired sample to obtain an Rf value and the separation degree between any two adjacent components of the developed plural components before performing liquid chromatography on the sample; the step of selecting a correspondence relationship stored in the storage means in reference to the obtained degree of separation; the step of obtaining, by interpolation, the appropriate sequence of solvent mixing ratios from the respective appropriate sequences of solvent mixing ratios of the Rf values on both sides of the obtained Rf value and adjacent to each other in the selected correspondence relationship; and the step of performing liquid chromatography according to the obtained appropriate sequence of solvent mixing ratios.

Further in this invention, yet another embodiment proposes a liquid chromatograph control method, comprising the step of performing thin layer chromatography on respective samples respectively containing plural components at a preset solvent mixing ratio to obtain Rf values and degrees of separation between developed plural components, performing liquid chromatography to obtain the appropriate sequences of solvent mixing ratios of liquid chromatography for the respective samples of each Rf values, for the respective degrees of separation between developed plural components, obtaining correction factor values corresponding to the respective degrees of separation for correcting the correspondence relationship in reference to the correspondence relationship for a certain degree of separation, and storing them in a storage means; the step of performing thin layer chromatography on a desired sample to obtain an Rf value and the separation degree between any two adjacent components of the developed plural components before performing the liquid chromatography on the sample; the step of reading the respective appropriate sequences of solvent mixing ratios of the Rf values on both sides of the obtained Rf value and adjacent to each other and the respective correction factor values from the storage means; the step of correcting the respective appropriate sequences of solvent mixing ratios by the correction factor values, and obtaining, by interpolation, the appropriate sequence of solvent mixing ratios corresponding to the obtained Rf value from the corrected appropriate sequences of solvent mixing ratios of the adjacent Rf values; and the step of performing liquid chromatography according to the obtained appropriate sequence of solvent mixing ratios.

Further in this invention, an alternate embodiment proposes that the Rf values of thin layer chromatography and the degrees of separation between developed plural components are obtained from the images of thin layer plates obtained by an imaging means.

Further in this invention, an embodiment propose that the degree of separation as a parameter is expressed with the distance between adjacent components as an indicator, with the difference between the inverse numbers of the Rf values of adjacent components as an indicator, or with the quotient of the Rf values of the substances A and B corresponding to adjacent components as an indicator.

Further in this invention, another embodiment proposes that the correspondence relationships are obtained for respective types of columns and are stored to allow selection for each type of columns.

Further in this invention, yet another embodiment proposes that the correspondence relationships are obtained for respective solvents and are stored to allow selection for each solvent.

Further in this invention, a further embodiment proposes that each of the correspondence relationships stored in the storage means is the direct relationship between Rf values and appropriate sequences of solvent mixing ratios.

Further in this invention, yet another embodiment proposes that each of the correspondence relationships stored in the storage means is a correspondence relationship between the function values of Rf values and appropriate sequences of solvent mixing ratios. Furthermore, a further aspect of the invention proposes that the function values of Rf values are the inverse numbers of Rf values.

Further in this invention, an embodiment proposes that the appropriate sequences of solvent mixing ratios stored in the storage means are the appropriate time sequences of solvent mixing ratios.

Further in this invention, another embodiment proposes that each of the appropriate sequences of solvent mixing ratios stored in the storage means is an appropriate sequence of the mixing ratio index values obtained with said preset solvent mixing ratio (solvent concentration) of thin layer chromatography as 1.

As described before, thin layer chromatography and liquid chromatography are substantially identical with each other in the principle of moving a sample mixture for separating it into respective components. So, there is correlativity between the retardation factor of a sample in thin layer chromatography and the elution time of the sample in liquid chromatography if the stationary phase is the same.

Therefore, according to this invention, the plural discrete Rf values of thin layer chromatography performed on respective samples at a preset solvent mixing ratio and appropriate sequences of solvent mixing ratios of liquid chromatography for the respective samples are obtained beforehand, and their correspondence relationship is stored. Before liquid chromatography is performed on a sample of interest, highly simple and rapid thin layer chromatography is performed to obtain an Rf value, and the appropriate sequence of solvent mixing ratios corresponding to the Rf value is obtained, by interpolation, from the stored correspondence relationship. So, the result obtained by performing highly simple and rapid thin layer chromatography can be effectively used for accurately performing liquid chromatography.

According to an aspect of the invention the separation degree between any two adjacent components of the plural components developed by thin layer chromatography can be taken into account for obtaining a correspondingly appropriate sequence of solvent mixing ratios. So, liquid chromatography can be appropriately performed even if there is a non-intended sample existing near the intended sample to be separated.

In this case, the separation degree between any two adjacent components of the plural components can be expressed with the distance between adjacent components as an indicator, or with the difference between the inverse numbers of the Rf values of adjacent components as an indicator, or with the quotient of the Rf values of the substances corresponding to adjacent components.

Since the results obtained by performing thin layer chromatography can be obtained by processing the images of thin layer plates, the appropriate sequences of solvent mixing ratios of liquid chromatography can be simply and rapidly obtained. Thus, the series of operations can be automated.

In this invention, if the correspondence relationships are obtained for respective types of columns and stored to allow selection for each type of columns, or obtained for respective solvents and stored to allow selection for each solvent, an appropriate sequence of solvent mixing ratios of liquid chromatography can be obtained simply and rapidly for each Rf value, each degree of separation, each type of columns, or each solvent.

In this invention, each of the correspondence relationships can be a direct correspondence relationship between Rf values and appropriate sequences of solvent mixing ratios, or a correspondence relationship between the function values of Rf values and appropriate sequences of solvent mixing ratios, for example, a correspondence relationship between the inverse numbers of Rf values and appropriate sequences of solvent mixing ratios.

Further, in this invention, each of the appropriate sequences of solvent mixing ratios stored in the storage means can be a time sequence of solvent mixing ratios per se, or a sequence of the mixing ratio index values obtained with said preset solvent mixing ratio (solvent concentration) of thin layer chromatography as 1. Meanwhile, the time sequence of solvent mixing ratios can be of either the stepwise control method (stepwise elution method) or the concentration gradient control method (gradient elution method).

### BRIEF DESCRIPTION OF THE DRAWINGS

FIG. 1 is a system diagram showing an example of the control apparatus of this invention applied to liquid chromatography;

FIG. 2 shows a correspondence relationship between Rf values and appropriate sequences of solvent mixing ratios stored in a storage means;

FIG. 3 shows an embodiment of how to obtain the appropriate sequence of solvent mixing ratios corresponding to an arbitrary Rf value by interpolation;

FIG. 4 shows another correspondence relationship between Rf values and appropriate sequences of solvent mixing ratios stored in a storage means;

FIG. 5 shows measured results as a relationship between the Rf values of thin layer chromatography and elution times of liquid chromatography;

FIG. 6 shows a further other correspondence relationship between Rf values and appropriate sequences of solvent mixing ratios stored in a storage means;

FIG. 7 is a graph showing the measured results of FIG. 5 as a relationship between the inverse numbers of Rf values and the elution times of liquid chromatography;

FIG. 8 shows a result obtained by performing thin layer chromatography;

FIGS. 9 (a)-9 (c) show further other correspondence relationships between Rf values and appropriate sequences of solvent mixing ratios stored in a storage means;

FIG. 10 is a diagram showing a result obtained by performing liquid chromatography;

FIG. 11 is a diagram showing a result obtained by performing liquid chromatography;

FIG. 12 is a diagram showing a result obtained by performing liquid chromatography;

FIG. 13 is a diagram showing a result obtained by performing liquid chromatography;

FIG. 14 is a diagram showing a result obtained by performing liquid chromatography; and

FIG. 15 is a diagram showing a result obtained by performing liquid chromatography.

### DETAILED DESCRIPTION OF THE INVENTION

This invention is explained below in detail in reference to the drawings showing embodiments.

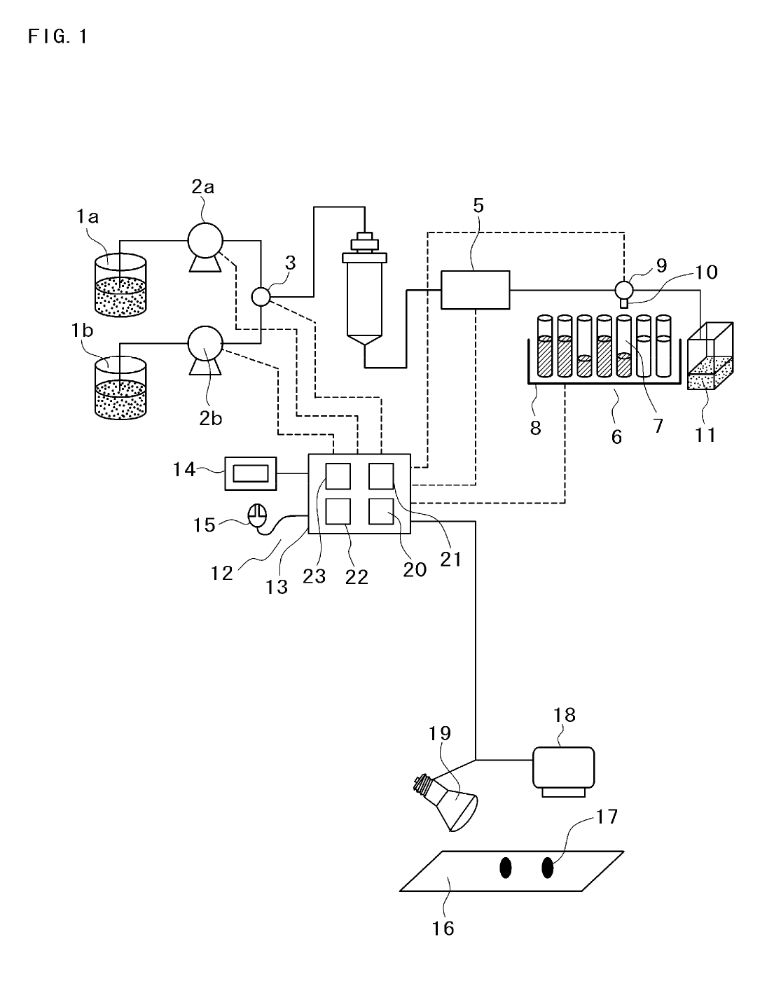

FIG. 1 shows a purification apparatus for purifying a novel synthetic compound such as a drug, agricultural chemical compound or industrial chemical compound, as a liquid chromatography application apparatus using the control apparatus of this invention.

Symbols 1a and 1b denote solvent tanks for storing the solvents to be mixed for forming the mobile phase of liquid chromatography. In the solvent tanks 1, plural solvents different in polarity must be placed in the case where stepwise control (stepwise elution method) or concentration gradient control (gradient elution method) is performed for purification.

Symbols 2a and 2b denote pumps for sucking and sending the solvents stored in the solvent tanks 1a and 1b to the column, detector and fraction collector described later. In this embodiment, two pumps are installed in correspondence to the solvent tanks 1a and 1b for feeding the solvents using a high pressure gradient method, and downstream of these pumps 2a and 2b, a mixer 3 is installed.

Symbol 4 denotes a column packed with the material used as the stationary phase of liquid chromatography.

Symbol 5 denotes a detector for allowing the liquid from the column 4 to pass through it for detecting whether or not a sample is contained in the mixed solvent (mobile phase). The detector 5 can be, for example, an absorbance detector, fluorescence detector or differential refractometer detector, etc.

Symbol 6 denotes a fraction collector, and the fraction collector 6 consists of a test tube rack 8 supporting many test tubes 7 arranged on it, a fractionation nozzle 10 with a valve 9 provided above the test tube rack 8 and capable of moving along the arranged test tubes 7, and a waste liquid tank 11. The valve 9 is a switching valve for switching between the fractionation to the test tube rack 8 and the liquid feed to the waste liquid tank 11.

Symbol 12 denotes a control apparatus, and the control apparatus 12 is a computer application apparatus consisting of a controller 13, a display 14, a pointing device 15 such as a mouse, etc.

Symbol 16 denotes a thin layer plate obtained by performing thin layer chromatography, and symbol 17 denotes a substance developed on the thin layer plate 16. Thin layer plates 16 are illuminated by an illuminator 19 and imaged by a camera 18, and the images are applied to an image processing means 20 constituting the controller 13.

Further, the controller 13 contains, as described later in detail, a storage means 21 for storing the correspondence relationships between the plural discrete Rf values obtained by thin layer chromatography performed on respective samples at a preset solvent mixing ratio and the appropriate sequences of solvent mixing ratios of liquid chromatography for the respective samples, an arithmetic means 22 for obtaining, by interpolation, the appropriate sequence of solvent mixing ratios corresponding to any Rf value falling between the stored Rf values adjacent to each other, and a control means 23 for controlling the pumps 2a and 2b, mixer 3, etc. according to the obtained appropriate sequence of solvent mixing ratios.

The correspondence relationship stored in the storage means 21 is explained below.

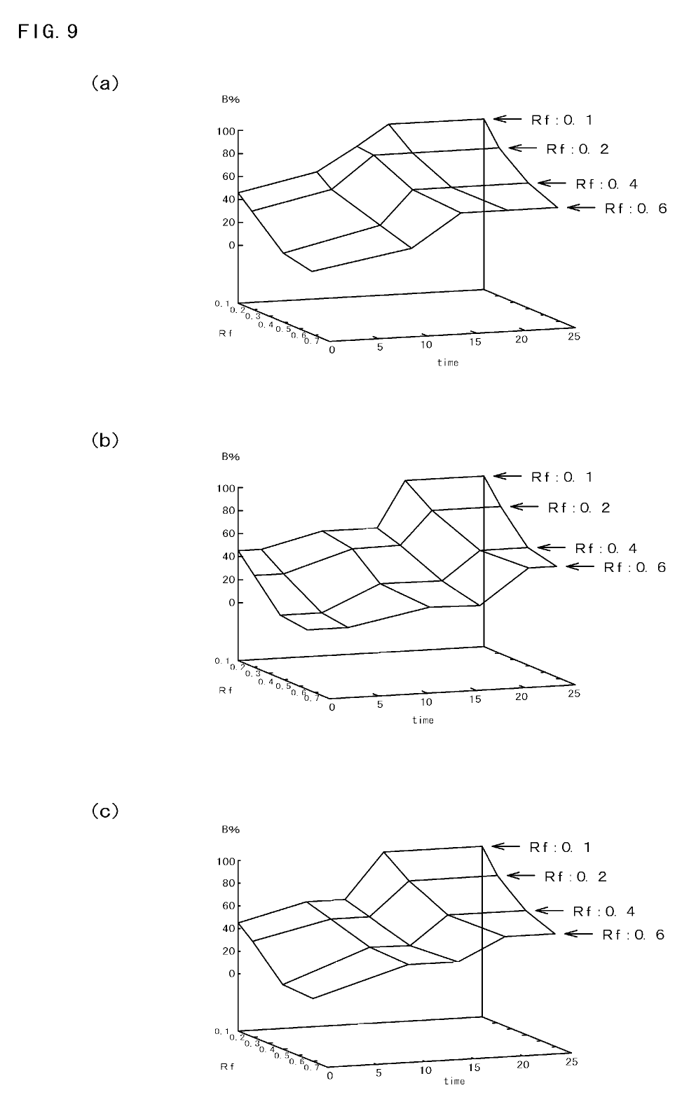

At first, in this invention, at a preset solvent mixing ratio, for example, at a solvent mixing ratio of 1:1 for two solvents, thin layer chromatography is performed on many samples using the same stationary phase as that of liquid chromatography, and from the results, Rf values are obtained, for example, as shown in FIG. 9. Next, liquid chromatography is performed on the respective samples according to plural sequences of solvent mixing ratios, and appropriate sequences of solvent mixing ratios are obtained for the respective samples showing respective Rf values. Each of the appropriate sequences of solvent mixing ratios is a time sequence of solvent mixing ratios in liquid chromatography, and decided for the stepwise control method or the concentration gradient control method.

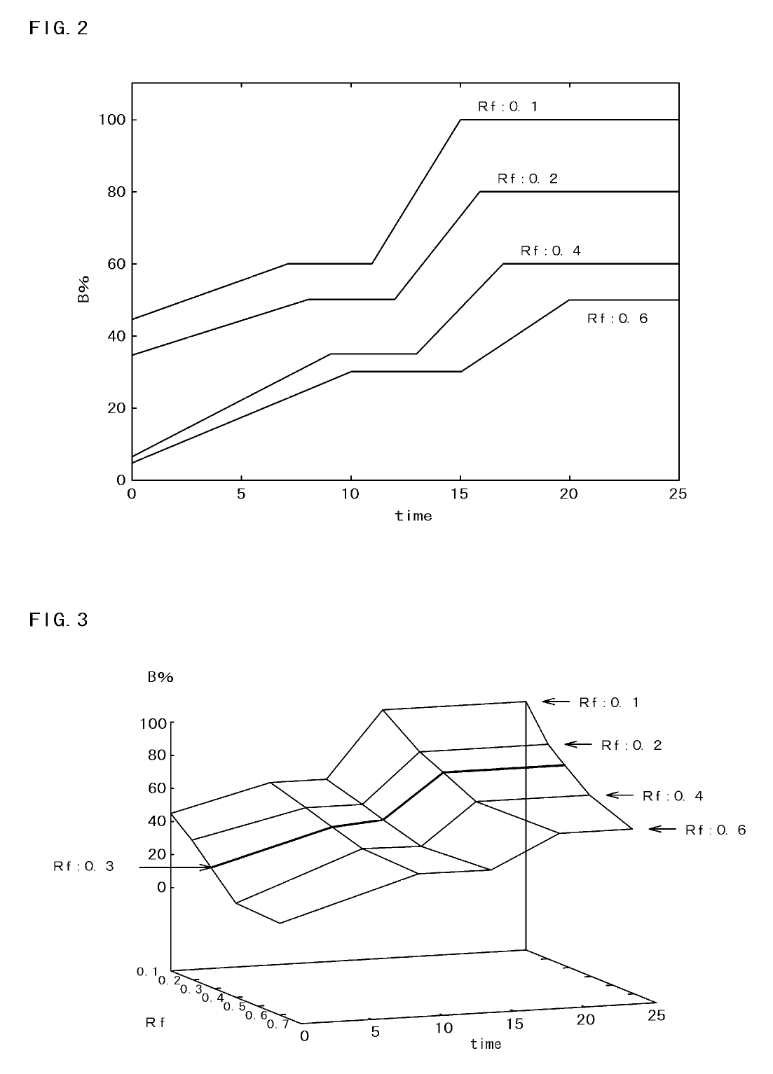

FIG. 2 typically shows a correspondence relationship obtained by the above method. The sequences of solvent mixing ratios in this correspondence relationship are for the concentration gradient control method, and the Rf values of samples for which appropriate sequences of solvent mixing ratios are obtained are discrete values like 0.1, 0.2, 0.4 and 0.6 as shown in FIG. 2.

In this invention, the correspondence relationship between Rf values and appropriate sequences of solvent mixing ratios as shown in FIG. 2 is stored in the storage means 21. In this case, the storage means 21 stores the concentration gradient, namely, solvent mixing ratio change rates corresponding to the time base and the solvent mixing ratio values at the positions where the concentration gradient changes. On the other hand, in the case where the stepwise control method is used, the storage means 21 can store the solvent mixing ratio values at the respective time points when the solvent mixing ratio changes.

In the above constitution, when liquid chromatography is performed on a sample of interest, highly simple and rapid thin layer chromatography is performed beforehand to obtain an Rf value, and the value is entered into the arithmetic means 22. The arithmetic means 22 that has received the Rf value obtains, by interpolation, the appropriate sequence of solvent mixing ratios for the Rf value from said correspondence relationship stored in the storage means 21.

That is, FIG. 3 typically shows the arithmetic operation by this interpolation on three-dimensional coordinates. In the case where the Rf value obtained by thin layer chromatography is 0.3, the appropriate sequence of solvent mixing ratios for the Rf value of 0.3 drawn as a thick line in the graph is obtained by interpolating the appropriate sequences of solvent mixing ratios for the discrete Rf values 0.2 and 0.4 adjacent to each other on both sides of 0.3.

Subsequently the control means 23 can control the pumps 2a and 2b, mixer 3, etc. based on the appropriate sequence of solvent mixing ratios obtained as described above, for performing liquid chromatography according to the appropriate sequence of solvent mixing ratios.

As the interpolation used for obtaining the appropriate sequence of solvent mixing ratios in this invention, any adequate method such as interpolation using a straight line or using a curved line can be applied.

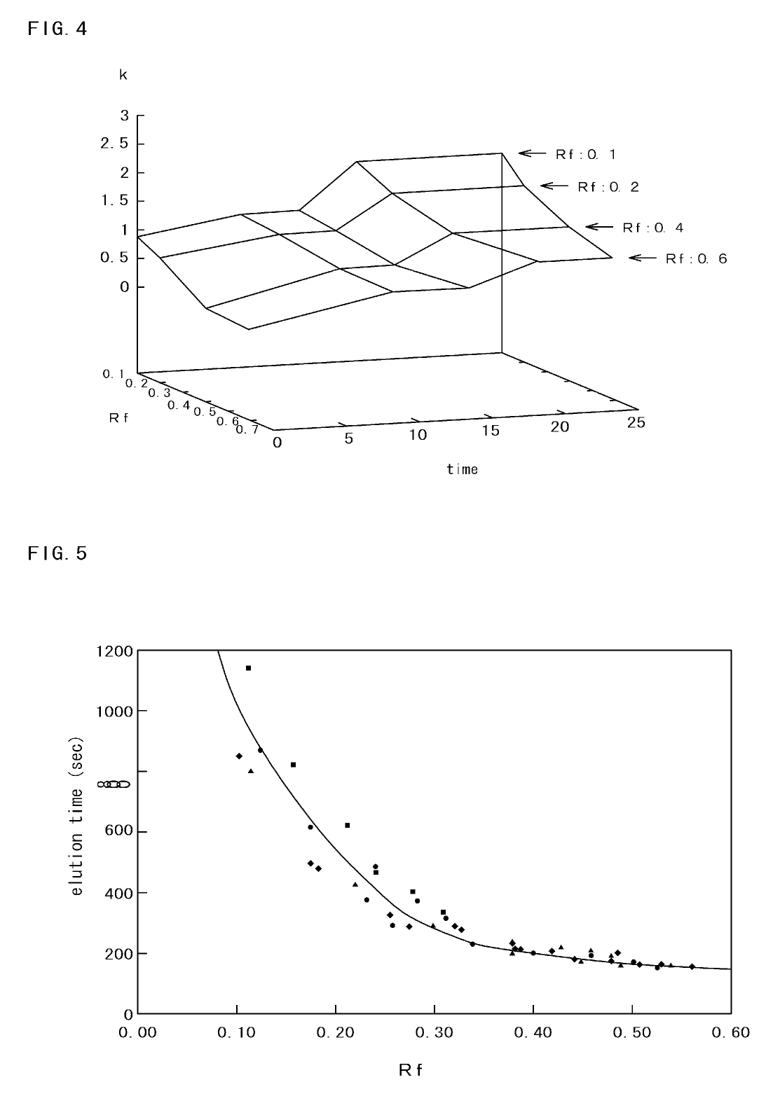

In the correspondence relationship between Rf values and appropriate sequences of solvent mixing ratios stored in the storage means 21, each of the appropriate sequences of solvent mixing ratios can be a time sequence of solvent mixing ratios as shown in FIG. 2, or a sequence of the mixing ratio index values obtained with said preset solvent mixing ratio (solvent concentration) of thin layer chromatography as 1 as shown in FIG. 4. For example, in the case of two solvents mixed at 1:1, if the rate of 50% for one solvent is as 1, an appropriate sequence of the mixing ratio index values obtained with said 50% as 1 can be used instead of the appropriate sequence of the corresponding solvent mixing ratios.

At a preset solvent mixing ratio, for example, at the solvent mixing ratio of 1:1 (50%), thin layer chromatography was performed on respective samples, to obtain Rf values, and liquid chromatography was performed at the same solvent mixing ratio, to obtain the measured elution times shown in FIG. 5. As can be seen from this graph, when the Rf value remained small, the change of elution time was large relatively to the change of Rf value, but when the Rf value became larger, the change of elution time became gradually smaller.

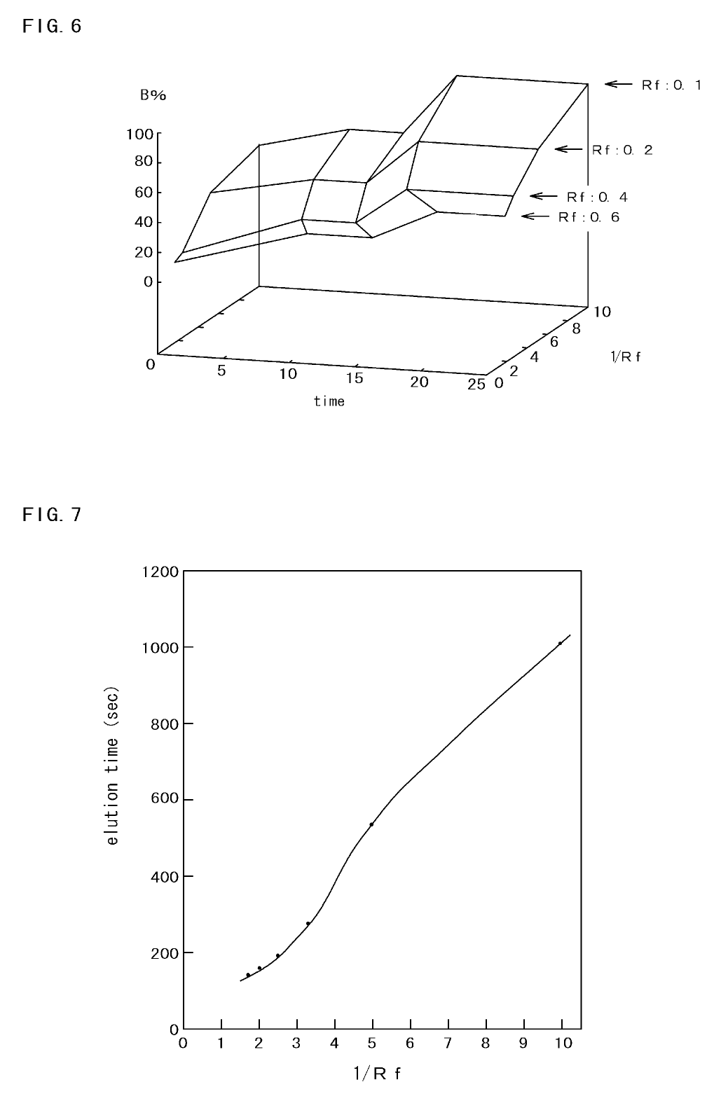

For this reason, in the correspondence relationship between plural discrete Rf values and appropriate sequences of solvent mixing ratios stored in the storage means 21, if the intervals between the plural Rf values are linearly set, the differences between the respective appropriate sequences of solvent mixing ratios corresponding to the Rf values adjacent to each other become small when the Rf values become large as shown in FIG. 6. Therefore, when the Rf values are large, calculation is difficult and large errors are likely to occur.

However, if the measured results of FIG. 5 are considered as the correspondence relationship between the inverse numbers of Rf values and elution times, the correspondence relationship can be expressed linearly as shown in FIG. 7. In this case, if the correspondence relationship between the function values of Rf values, for example, the inverse numbers of Rf values and appropriate sequences of solvent mixing ratios is employed as the correspondence relationship stored in the storage means 21, instead of the direct correspondence relationship between Rf values and appropriate sequences of solvent mixing ratios as shown in FIGS. 2 and 3, calculation is easy and errors can be kept small.

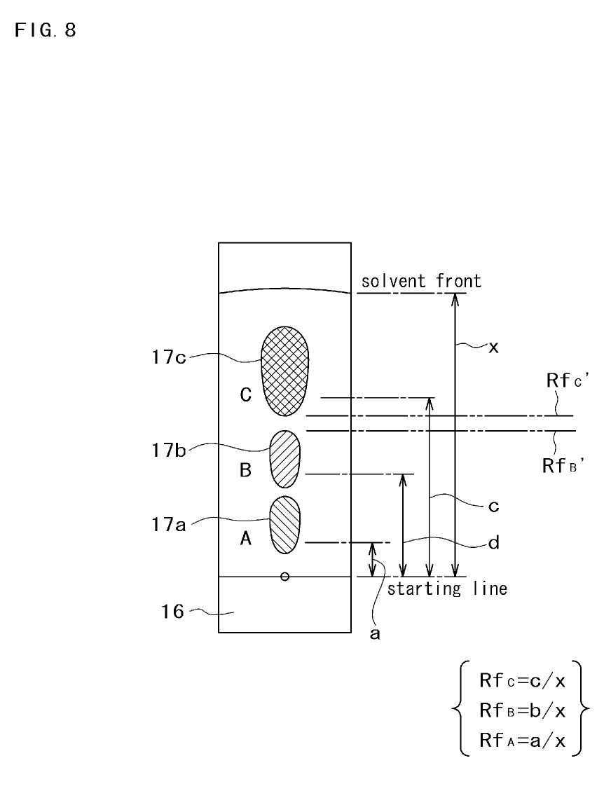

On the other hand, FIG. 8 typically shows the results of thin layer chromatography performed on a sample containing plural components, namely, substances A, B and C in this case. In FIG. 8, in the case where the distance between Rf_{C′} and Rf_{B′} is small, namely, in the case where a non-intended substance exists near an intended substance to be separated from a sample, it is desired that the elution times of the respective substances become sufficiently long in liquid chromatography.

So, in normal phase liquid chromatography, it is effective to keep the mixing ratio of a highly polar solvent lower so that it can take more time in passing through the column. On the contrary, in the case where a non-intended substance does not exist near an intended substance to be separated from a sample, liquid chromatography can be accomplished in a shorter period of time for shortening the time and for decreasing the amount of the solvent used.

This suggests that it is desirable to set the sequence of solvent mixing ratios of liquid chromatography, considering not only the Rf values of thin layer chromatography but also the separation degree between any two adjacent components of the plural components developed by thin layer chromatography.

So, as one embodiment of this invention, the correspondence relationships between the plural discrete Rf values obtained by thin layer chromatography performed on respective samples containing plural components at a preset solvent mixing ratio and the appropriate sequences of solvent mixing ratios of liquid chromatography for the respective samples is stored in the storage means 21, with the separation degree between any two adjacent components of the plural components developed by thin layer chromatography as a parameter.

For example, in FIGS. 9 (a), (b), and (c), the separation degrees between any two adjacent components of plural components as a parameter are considered in three separation degree ranges: large range, medium range and small range. The correspondence relationships between the plural discrete Rf values and the appropriate sequences of solvent mixing ratios of liquid chromatography for the respective samples as shown in FIGS. 9 (a), (b) and (c) for the respective separation degree ranges are stored like FIGS. 2 and 3.

In the constitution described above, the controller 13 has a selection means (not shown in the drawing) for selecting the correspondence relationship between the plural discrete Rf values and the appropriate sequences of solvent mixing ratios of liquid chromatography for the respective samples, corresponding to the separation degree between any two adjacent components of the plural components obtained by thin layer chromatography and entered into the controller 13, from the correspondence relationships stored in the storage means 21, and the arithmetic means 22 obtains, by interpolation, the appropriate sequence of solvent mixing ratios corresponding to the entered Rf value from the selected correspondence relationship.

Thus, the appropriate sequences of solvent mixing ratios can be set into the control means, considering not only the Rf values of thin layer chromatography but also the separation degree between any two adjacent components of the plural components developed by thin layer chromatography, to perform liquid chromatography.

On the other hand, as the separation degree between any two adjacent components of the plural components, the difference between the inverse numbers of the Rf values of the adjacent components can also be used as an indicator. That is, if the indicator of the separation degree is X and the Rf values of the substances A and B are Rf_{A} and Rf_{B}, then the following is the indicator indicating the separation degree.

X=(1/Rf_{A})−(1/Rf_{B})

In the above, as the case of (a), if the Rf_{A} value is 0.10 and the Rf_{B} value is 0.15, then we have X=3.34. Further, as the case of (b), if the Rf_{A} value is 0.45 and the Rf_{B} value is 0.5, then we have X=0.2. That is, even in both the cases where the difference between Rf values is 0.05, said indicator X can have values showing clear differences.

Considering the actual relationship between Rf values and elution times, in the case of (a), the elution times are greatly different, and therefore separation is easy. On the contrary, in the case of (b), the elution times are not so different, and therefore it is evident that separation is difficult. If the appropriate sequences of solvent mixing ratios considering not only the Rf values of thin layer chromatography but also the separation degree between any two adjacent components of the plural components developed by thin layer chromatography are set into the control means, liquid chromatography can be effectively performed.

That is, since the indicator X is large in the case of (a), the appropriate sequence of solving mixing ratios of liquid chromatography can be set to assure shorter elution times, and since the indicator X is small in the case of (b) on the contrary, the appropriate sequence of solvent mixing ratios of liquid chromatography can be set to assure longer elution times. Therefore, even if the separation degree between any two adjacent components of the plural components developed by thin layer chromatography is different, liquid chromatography can be performed according to an appropriate sequence of solvent mixing ratios.

Further, for the separation degree between any two adjacent components of the plural components, the quotient of the Rf values of the adjacent components can also be used as the indicator. That is, if the indicator indicating the separation degree is Y and the Rf values of substances A and B are Rf_{A} and Rf_{B}, then the following is the indicator indicating the separation degree.

Y=Rf_{A}/Rf_{B} (or Y=Rf_{B}/Rf_{A})

In the above, as described before, in the case of (a), if the Rf_{A} value is 0.10 and the Rf_{B} value is 0.15, then we have Y=0.67. Further, in the case of (b), if the Rf_{A} value is 0.45 and the Rf_{B} value is 0.5, then we have Y=0.9. That is, even in both the cases where the difference between Rf values is 0.05, said indicator Y can have values showing clear differences.

Therefore, since the indicator Y is small in the case of (a), the appropriate sequence of solvent mixing ratios of liquid chromatography can be set to assure shorter elution time, and since the indicator Y is large in the case of (b) on the contrary, the appropriate sequence of solvent mixing ratios can be set to assure longer elution times. Thus, liquid chromatography can be performed according to an appropriate sequence of solvent mixing ratios.

In the embodiments explained above, the storage means stores the correspondence relationship between the plural discrete Rf values obtained by thin layer chromatography performed on respective samples at a preset solvent mixing ratio and the appropriate sequences of solvent mixing ratios of liquid chromatography for the respective samples, or said correspondence relationship further involving the separation degree between any two adjacent components of the plural components developed by thin layer chromatography as a parameter. In a further other embodiment, the storage means can store the correspondence relationship between the plural discrete Rf values obtained by thin layer chromatography performed on respective samples respectively containing plural components at a preset solvent mixing ratio and the appropriate sequences of solvent mixing ratios of liquid chromatography, and can also store the correction factor values corresponding to the separation degrees between any two adjacent components of the plural components developed by thin layer chromatography, for said correspondence relationship.

In this case, in the case where the concentration gradient control method is applied, as described before, the correspondence relationship stored in the storage means 21 is, as shown in FIG. 2, etc., the correspondence relationship between the concentration gradient corresponding to the time base, namely, the solvent mixing ratio change rates and the solvent mixing ratio values at the positions where the concentration gradient changes, and this correspondence relationship is of a certain reference separation degree, for example, for the medium separation degree range. The storage means 21 stores the correction factor values corresponding to the said separation degree ranges for each correspondence relationship.

The correction factor can be adequately set for the above-mentioned respective ranges of separation degrees. For example, in the case where the medium range of separation degrees is selected as the reference range, the correction factor can be set at 1 for the reference range of separation degrees.

Further, for example as shown in FIG. 2, etc., in the case where the correspondence relationship stored in the storage means 21 is a correspondence relationship between the concentration gradient corresponding to the time base, namely, the solvent mixing ratio change rates and the solvent mixing ratio values at the positions where the concentration gradient changes, the same correction factor value can be applied to all the stored values of the correspondence relationship, or different correction factor values can be applied selectively to different portions of the correspondence relation. In the latter case, the storage means 21 stores plural correction factors for one correspondence relationship.

In addition to the above, the correspondence relationships obtained for the respective types of columns and/or the respective solvents can be stored in the storage means 21, so that the correspondence relationships between the plural discrete Rf values obtained by thin layer chromatography performed on respective samples at a preset solvent mixing ratio and the appropriate sequences of solvent mixing ratios of liquid chromatography for the respective samples can be stored with the type of columns and/or the solvent as parameters, or that these correspondence relationships can also be stored with the separation degree between any two adjacent components of the plural components developed by thin layer chromatography as a parameter.

In the case where the storage means 21 stores those correspondence relationships using the above parameters, the controller 13 can have a selection means (not shown in the drawings). In this case, when any one of the parameters is applied to the controller 13, the selection means selects the correspondence relationship between plural discrete Rf values and appropriate sequences of solvent mixing ratios, corresponding to the applied parameter. That is, the selection means selects the correspondence relationship corresponding to the applied parameter, from the correspondence relationships stored in the storage means 21. Then, the arithmetic means 22 is used to obtain the appropriate sequence of solvent mixing ratios for the entered Rf value from the selected correspondence relationship.

As described above, if the constitution as shown in FIG. 1 is employed, the images of the thin layer plates 16 obtained as the results of performing thin layer chromatography can be processed by the image processing means 21, and the appropriate sequence of solvent mixing ratios of liquid chromatography can be simply and rapidly obtained. Further, the series of operation can be automated.

### EXAMPLE 1

An example of this invention is explained below.

Table 1 shows an example of the correspondence relationship between Rf values and appropriate sequences of solvent mixing ratios stored in the storage means 21. The appropriate sequences of solvent mixing ratios are for the concentration gradient control (gradient elution method), and the solvent mixing ratios (solvent concentrations) at the respective time points (1) through (6) are not stored as actual values, but as the mixing ratio index values obtained with said preset solvent mixing ratio (solvent concentration) of thin layer chromatography as 1. The solvents used for thin layer chromatography are hexane and ethyl acetate, and the solvent mixing ratio (the solvent concentration) as 1 is an ethyl acetate concentration of 30% (a solvent mixture consisting of 70% of hexane and 30% of ethyl acetate).

TABLE 1

| | | Mixing ratio index value obtained with the |
|---|---|---|
| | | preset solvent mixing ratio |
| | Time (min) | (solvent concentration) of TLC as 1 |
| Rf = 0.3 | | |
| (1) | 0 | 0.45 |
| (2) | 3 | 0.45 |
| (3) | 12 | 0.65 |
| (4) | 20 | 0.65 |
| (5) | 25 | 2.70 |
| (6) | 30 | 2.70 |
| Rf = 0.2 | | |
| (1) | 0 | 0.65 |
| (2) | 3 | 0.65 |
| (3) | 12 | 0.95 |
| (4) | 20 | 0.95 |
| (5) | 25 | 4.00 |
| (6) | 30 | 4.00 |

In this situation, if the Rf value obtained by performing thin layer chromatography is 0.28 before liquid chromatography is performed for the sample of interest, the appropriate sequence of solvent mixing ratios for the Rf value is obtained, by interpolation, from the correspondence relationship of Table 1 stored in the storage means 21.

Table 2 shows the results obtained by linear interpolation. The solvent mixing ratios at the respective time points (1) through (6) corresponding to the Rf value of 0.28 are obtained as the mixing ratio index values with the solvent mixing ratio (solvent concentration) of thin layer chromatography as 1. From the mixing ratio index values and the solvent mixing ratio (solvent concentration) of thin layer chromatography, the solvent mixing ratios at the respective time points (1) through (6) can be obtained.

TABLE 2

| | | Mixing ratio index | |
|---|---|---|---|
| | | value obtained with the | |
| | Time | preset solvent mixing ratio (solvent | Ethyl acetate |
| Rf = 0.28 | (min) | concentration) of TLC as 1 | concentration % |
| (1) | 0 | 0.49 | 15 |
| (2) | 3 | 0.49 | 15 |
| (3) | 12 | 0.71 | 21 |
| (4) | 20 | 0.71 | 21 |
| (5) | 25 | 2.96 | 89 |
| (6) | 30 | 2.96 | 89 |

### EXAMPLE 2

Tables 3 and 4 show a particular example of the operation for selecting a correspondence relationship stored in the storage means 21 in reference to the separation degree and the operation for obtaining the quotient of the Rf values of the substances corresponding to the components adjacent to each other as the separation degree indicator.

Table 3 shows the stored appropriate sequences of solvent mixing ratios of liquid chromatography for a case of separation degree indicator≧0.8 where the separation degree is small. As in Table 1, the solvent mixing ratios (solvent concentrations) at the respective time points (1) through (6) are not stored as actual values, but as the mixing ratio index values obtained with said preset solvent mixing ratio (solvent concentration) of thin layer chromatography as 1.

TABLE 3

| | | Mixing ratio index value obtained with the |
|---|---|---|
| | | preset solvent mixing ratio |
| | Time (min) | (solvent concentration) of TLC as 1 |
| Rf = 0.3 | | |
| (1) | 0 | 0.45 |
| (2) | 3 | 0.45 |
| (3) | 12 | 0.65 |
| (4) | 20 | 0.65 |
| (5) | 25 | 2.70 |
| (6) | 30 | 2.70 |
| Rf = 0.2 | | |
| (1) | 0 | 0.65 |
| (2) | 3 | 0.65 |
| (3) | 12 | 0.95 |
| (4) | 20 | 0.95 |
| (5) | 25 | 4.00 |
| (6) | 30 | 4.00 |

Table 4 shows the appropriate sequences of solvent mixing ratios of liquid chromatography stored for a case of 0.3<separation degree indicator<0.8 where the separation degree is medium.

TABLE 4

| | | Mixing ratio index value obtained with the |
|---|---|---|
| | | preset solvent mixing ratio |
| | Time (min) | (solvent concentration) of TLC as 1 |
| Rf = 0.3 | | |
| (1) | 0 | 0.72 |
| (2) | 1.5 | 0.72 |
| (3) | 7 | 1.08 |
| (4) | 12 | 1.08 |
| (5) | 15 | 2.50 |
| (6) | 20 | 2.50 |
| Rf = 0.2 | | |
| (1) | 0 | 1.15 |
| (2) | 1.5 | 1.15 |
| (3) | 7 | 1.60 |
| (4) | 12 | 1.60 |
| (5) | 15 | 3.80 |
| (6) | 20 | 3.80 |

Table 5 shows the Rf values of the respective substances A, B and C obtained by performing thin layer chromatography at the aforesaid preset solving mixing ratio.

TABLE 5

| | A | B | C |
|---|---|---|---|
| Name of | Butyl p- | Methyl p- | p-anisyl |
| compound | hydroxybenzoate | hydroxybenzoate | alcohl |
| Structuralformula | 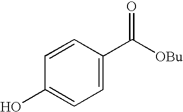 | 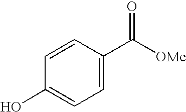 | 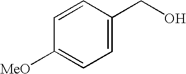 |
| Rf value | 0.28 | 0.23 | 0.15 |

In the operation for obtaining the appropriate sequence of solvent mixing ratios for the purpose of fractionation between the substances A and B and between the substances A and C by liquid chromatography, if the quotients of Rf values of the substances to be fractionated are employed as separation degree indicators, the indicator of the separation degree between the substances A and B and the indicator of the separation degree between the substances A and C are as shown below. Indicator of the separation degree between substances A and B: Rf_{B}/Rf_{A}=0.83 Indicator of the separation degree between substances A and C: Rf_{C}/Rf_{A}=0.53 Therefore, in the case where the correspondence relationships stored in the storage means 21 are selected in reference to the separation degrees, if the quotients of the Rf values of the components adjacent to each other are employed as separation degree indicators, the correspondence relationship shown in Table 3 should be selected for the separation degree indicator of 0.83 for fractionation between the substances A and B, and the correspondence relationship shown in Table 4 should be selected for the separation degree indicator of 0.53 for fractionation between the substances A and C.

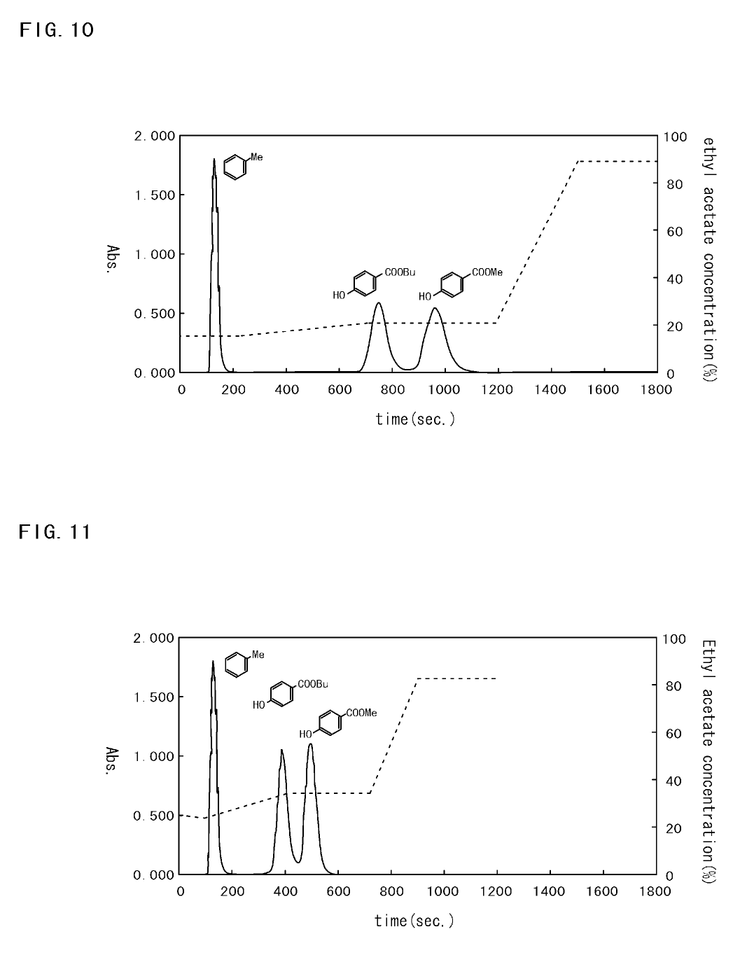

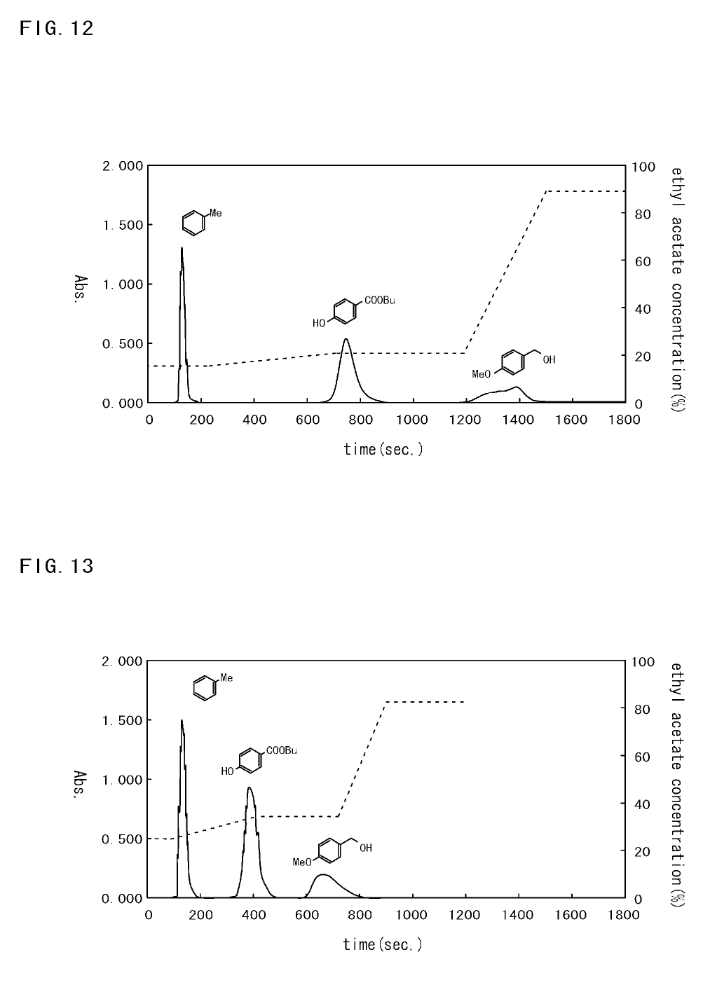

If the fractionation between the substances A and B and the fractionation between the substances A and C by liquid chromatography are performed by selecting the correspondence relationships shown in Tables 3 and 4, the results are as shown in FIGS. 10 to 13. In the graphs, the dotted lines indicate the solvent mixing ratios, namely, ethyl acetate concentrations (%) in this case. The appropriate sequence of solvent mixing ratios corresponding to the Rf value of 0.28 in the case where the correspondence relationship shown in Table 3 is selected is the solvent mixing ratios of Table 6 similar to Table 2, and the appropriate sequence of solvent mixing ratios corresponding to the Rf value of 0.28 in the case where the correspondence relationship shown in Table 4 is selected can be obtained from the correspondence relationship shown in Table 4 by linear interpolation, as the solvent mixing ratios shown in Table 7.

TABLE 6

| | Time (min) | Ethyl acetate concentration % |
|---|---|---|
| (1) | 0 | 15 |
| (2) | 3 | 15 |
| (3) | 12 | 21 |
| (4) | 20 | 21 |
| (5) | 25 | 89 |
| (6) | 30 | 89 |

TABLE 7

| | Time (min) | Ethyl acetate concentration % |
|---|---|---|
| (1) | 0 | 24 |
| (2) | 1.5 | 24 |
| (3) | 7 | 35 |
| (4) | 12 | 35 |
| (5) | 15 | 83 |
| (6) | 20 | 83 |

As shown in FIGS. 10 to 13, the fractionation between the substances A and B can be achieved well by employing the solvent mixing ratios of Table 6, but the separation cannot be achieved sufficiently by employing the solvent mixing ratios of Table 7. On the other hand, the fractionation between the substances A and C can be achieved sufficiently by employing either the solvent mixing ratios of Table 6 or the solvent mixing ratios of Table 7, but considering the time spent, it can be seen that employing the solvent mixing ratios of Table 7 is more efficient.

### EXAMPLE 3

An example concerning the operation for correcting the correspondence relationship stored in the storage means by a correction factor is explained below. Table 8 shows the Rf values of substances A and D obtained by performing thin layer chromatography at the aforesaid preset solvent mixing ratio. The substance A is already described before.

TABLE 8

| | A | D |
|---|---|---|
| Name of | Butyl p- | Veratryl |
| compound | hydroxybenzoate | alcohl |
| Structuralformula | 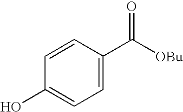 | 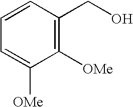 |
| Rf value | 0.28 | 0.07 |

In the operation of obtaining the appropriate sequence of solvent mixing ratios for the purpose of fractionation between the substances A and D by liquid chromatography, the quotient of the Rf values of the substances to be fractionated as the separation degree indicator is as follows.

Indicator of the separation degree between substances A and D: Rf_{D}/Rf_{A}=0.25

If this separation degree indicator is divided by the separation degree indicator for substances A and C of Rf_{C}/Rf_{A}=0.53 in the medium separation degree range as described before, to obtain the quotient as a correction factor Q, we have

Q=(Rf_{D}/Rf_{A})/(Rf_{C}/Rf_{A})=0.47

The correction factor Q is an indicator for the medium separation degree range.

If Q is equal to 1, the separation is as easy as the separation performed without correction.
If Q is larger than 1, the separation is more difficult than the separation performed without correction.
If Q is smaller than 1, the separation is easier than the separation performed without correction.

That is, the correction factor value of Q=0.47 for the substances A and D shows that separation is very easy.

Table 9 shows an example of correction by the correction factor Q corresponding to the separation degree between any two adjacent components of the plural components developed by thin layer chromatography. In this example, as shown in Table 9, the storage means 21 stores a correction factor sequence for elapsed times and a correction factor sequence for solvent mixing ratios at respective time points (1) through (6), and the value of Q is used to directly obtain the appropriate sequence of solvent mixing ratios. That is, the appropriate sequence of solvent mixing ratios of Table 7 is corrected by the correction factor Q stored as shown in Table 9, to obtain the appropriate sequence of solvent mixing ratios as shown in Table 10. Meanwhile, in Table 10, the values at time points (5) and (6) are written as 100%, since the calculated values are larger than 100%.

TABLE 9

| | | Correction factor for solvent |
|---|---|---|
| | Correction factor for time | concentration |
| (1) | 1 | 1 |
| (2) | 1 | 1 |
| (3) | Q | 1/Q |
| (4) | Q | 1/Q |
| (5) | Q | 1/Q |
| (6) | 1 | 1/Q |

TABLE 10

| | Time | Ethyl acetate concentration (%) |
|---|---|---|
| (1) | 0 | 24 |
| (2) | 1.5 | 24 |
| (3) | 3.3 | 74 |
| (4) | 5.6 | 74 |
| (5) | 7 | 100 |
| (6) | 20 | 100 |

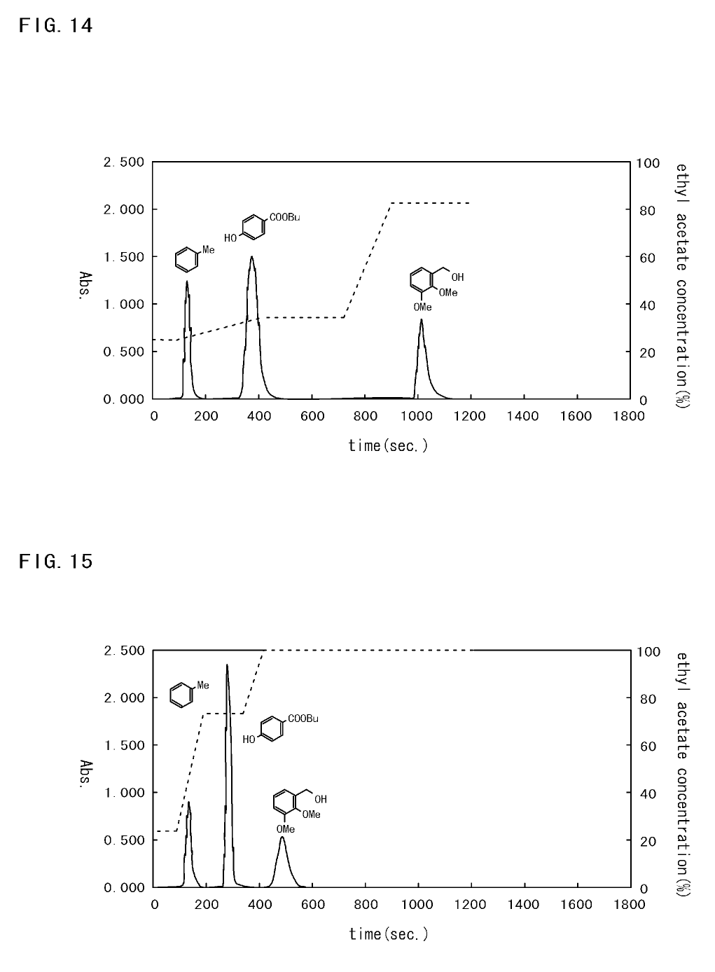

FIG. 14 shows the result of fractionation between the substances A and D by liquid chromatography according to the appropriate sequence of solvent mixing ratios shown in Table 7 not corrected by the correction factor Q. FIG. 15 shows the result of fractionation between the substances A and D by liquid chromatography according to the appropriate sequence of solvent mixing ratios shown in Table 10 corrected by the correction factor Q.

As can be seen from FIGS. 14 and 15, the fractionation between the substances A and D could be achieved with sufficient separation in both the cases. However, in the case where the correction factor Q was used for correction, the fractionation with sufficient separation could be accomplished in a shorter period of time, and considering the spent time, it can be seen that the liquid chromatography performed according to the appropriate sequence of solvent mixing ratios corrected by the correction factor was more efficient.

### EXAMPLE 4

Table 11 shows another example of correction by the values of correction factor Q corresponding to the separation degrees between any two adjacent components of the plural components developed by thin layer chromatography. As shown in the table, the storage means 21 stores correction factor sequences for elapsed times and correction factor sequences for solvent mixing ratios at respective time points (1) through (6) with the value of correction factor Q as a parameter.

TABLE 11

| | Correction factor for | Correction factor for solvent |
|---|---|---|
| | time | concentration |
| Q = 1.5 | | |
| (1) | 1 | 1 |
| (2) | 2 | 1 |
| (3) | 2 | 0.65 |
| (4) | 2 | 0.65 |
| (5) | 2 | 1 |
| (6) | 2 | 1 |
| Q = 1.2 | | |
| (1) | 1 | 1 |
| (2) | 1.5 | 1 |
| (3) | 1.5 | 0.8 |
| (4) | 1.5 | 0.8 |
| (5) | 1.5 | 1 |
| (6) | 1.5 | 1 |
| Q = 0.8 | | |
| (1) | 1 | 1 |
| (2) | 1 | 1 |
| (3) | 0.85 | 1.2 |
| (4) | 0.85 | 1.2 |
| (5) | 0.85 | 1.2 |
| (6) | 1 | 1.2 |
| Q = 0.5 | | |
| (1) | 1 | 1 |
| (2) | 1 | 1 |
| (3) | 0.6 | 1.8 |
| (4) | 0.6 | 1.8 |
| (5) | 0.6 | 1.8 |
| (6) | 0.8 | 1.8 |

In this example, the value of correction factor Q suitable for the separation degree concerned is selected from the values stored in the storage means, or the correction factor value suitable for the separation degree concerned is obtained, by interpolation, from the values stored in the storage means. The selected or calculated correction factor value is used to correct, for example, the appropriate sequence of solvent mixing ratios of Table 7, for obtaining a corrected appropriate sequence of solvent mixing ratios.

According to this invention, as described above, the results obtained by performing highly simple and rapid thin layer chromatography can be used for accurately performing liquid chromatography. So, this invention can be highly applied to the liquid chromatography performed for purification or analysis.

What is claimed is:

1. A liquid chromatograph control apparatus for controlling the solvent mixing ratios of liquid chromatography, comprising:
a storage device storing the correspondence relationship between the plural discrete retardation factor (“Rf”) values obtained by thin layer chromatography performed on respective samples at a preset solvent mixing ratio and the appropriate sequences of solvent mixing ratios of liquid chromatography for the respective samples; and
an arithmetic device obtaining, by interpolation, the appropriate sequence of solvent mixing ratios corresponding to any Rf value falling between the stored Rf values adjacent to each other.

2. A liquid chromatograph control apparatus for controlling the solvent mixing ratios of liquid chromatography, comprising:
a storage device storing the correspondence relationship between the plural discrete retardation factor (“Rf”) values obtained by thin layer chromatography performed on respective samples at a preset solvent mixing ratio and the appropriate sequences of solvent mixing ratios of liquid chromatography for the respective samples;
an arithmetic device obtaining, by interpolation, the appropriate sequence of solvent mixing ratios corresponding to any Rf value falling between the stored Rf values adjacent to each other; and
an image processing device imaging the thin layer plates obtained by performing thin layer chromatography, to obtain (retardation factor (“Rf”) values from the images.

3. A liquid chromatograph control apparatus for controlling the solvent mixing ratios of liquid chromatography, comprising:
a storage device storing the correspondence relationships between the plural discrete retardation factor (“Rf”) values obtained by thin layer chromatography performed on respective samples respectively containing plural components at a preset solvent mixing ratio and the appropriate sequences of solvent mixing ratios of liquid chromatography for the respective samples, with the separation degree between any two adjacent components of the plural components developed by thin layer chromatography as a parameter;
a selection device selecting a correspondence relationship stored in the storage device in reference to the separation degree between the corresponding two adjacent components of the plural components; and
an arithmetic device obtaining, by interpolation, the appropriate sequence of solvent mixing ratios corresponding to any Rf value falling between the stored Rf values adjacent to each other in the selected correspondence relationship.

4. A liquid chromatograph control apparatus for controlling the solvent mixing ratios of liquid chromatography, comprising:
a storage device storing the correspondence relationship between the plural discrete retardation factor (“Rf”) values obtained by thin layer chromatography performed on respective samples respectively containing plural components at a preset solvent mixing ratio and the appropriate sequences of solvent mixing ratios of liquid chromatography for the respective samples, and further for storing the correction factor values corresponding to the respective degrees of separation between any two adjacent components of the plural components developed by thin layer chromatography, for correcting the correspondence relationship; and
an arithmetic device correcting the correspondence relationship stored in the storage device by the correction factor value corresponding to the separation degree between the corresponding two adjacent components of the plural components and further for obtaining, by interpolation, the appropriate sequence of solvent mixing ratios corresponding to any Rf value falling between the stored Rf values adjacent to each other in the corrected correspondence relationship.

5. A liquid chromatograph control apparatus for controlling the solvent mixing ratios of liquid chromatography, comprising:
a storage device storing the correspondence relationships between the plural discrete retardation factor (“Rf”) values obtained by thin layer chromatography performed on respective samples respectively containing plural components at a preset solvent mixing ratio and the appropriate sequences of solvent mixing ratios of liquid chromatography for the respective samples, with the separation degree between any two adjacent components of the plural components developed by thin layer chromatography as a parameter;
a selection device selecting a correspondence relationship stored in the storage device in reference to the separation degree between the corresponding two adjacent components of the plural components;
an arithmetic device obtaining, by interpolation, the appropriate sequence of solvent mixing ratios corresponding to any Rf value falling between the stored Rf values adjacent to each other in the selected correspondence relationship; and
an image processing device imaging the thin layer plates obtained by performing thin layer chromatography, to obtain the distances between the developed plural components and Rf values from the images.

6. A liquid chromatograph control apparatus, according to claim 3, wherein the selection device is a manual selection device for manually selecting a correspondence relationship stored in the storage device in reference to the separation degree between the corresponding two adjacent components of the plural components.

7. A liquid chromatograph control apparatus, according to claim 3, wherein the selection device is an automatic selection device for automatically selecting a correspondence relationship stored in the storage device in reference to the separation degree between the corresponding two adjacent components of the plural components.

8. A liquid chromatograph control apparatus for controlling the solvent mixing ratios of liquid chromatography, comprising:
a storage device storing the correspondence relationship between the plural discrete retardation factor (“Rf”) values obtained by thin layer chromatography performed on respective samples respectively containing plural components at a preset solvent mixing ratio and the appropriate sequences of solvent mixing ratios of liquid chromatography for the respective samples, and further for storing the correction factor values corresponding to the respective degrees of separation between any two adjacent components of the plural components developed by thin layer chromatography, for correcting the correspondence relationship;
an arithmetic device correcting the correspondence relationship stored in the storage device by the correction factor value corresponding to the separation degree between the corresponding two adjacent components of the plural components and further for obtaining, by interpolation, the appropriate sequence of solvent mixing ratios corresponding to any Rf value falling between the stored Rf values adjacent to each other in the corrected correspondence relationship;
and an image processing device imaging the thin layer plates obtained by performing thin layer chromatography, to obtain the distances between the plural components and Rf values from the images.

9. A liquid chromatograph control apparatus, according to claim 3, wherein the degree of separation is expressed with the distance between adjacent components as an indicator.

10. A liquid chromatograph control apparatus, according to claim 3, wherein the degree of separation is expressed with the difference between the inverse numbers of the Rf values of adjacent components as an indicator.

11. A liquid chromatograph control apparatus, according to claim 3, wherein the degree of separation is expressed with the quotient of the Rf values of the substances corresponding to adjacent components as an indicator.

12. A liquid chromatograph control apparatus, according to claim 1, wherein the correspondence relationships are obtained for respective types of columns and are stored to allow selection for each type of columns.

13. A liquid chromatograph control apparatus, according to claim 1, wherein the correspondence relationships are obtained for respective solvents and are stored to allow selection for each solvent.

14. A liquid chromatograph control apparatus, according to claim 1, wherein each of the correspondence relationships stored in the storage means is the direct relationship between Rf values and appropriate sequences of solvent mixing ratios.

15. A liquid chromatograph control apparatus, according to claim 1, wherein each of the correspondence relationships stored in the storage means is a correspondence relationship between the function values of Rf values and appropriate sequences of solvent mixing ratios.

16. A liquid chromatograph control apparatus, according to claim 15, wherein the function values of Rf values are the inverse numbers of Rf values.

17. A liquid chromatograph control apparatus, according to claim 1, wherein the appropriate sequences of solvent mixing ratios stored in the storage means are appropriate time sequences of solvent mixing ratios.

18. A liquid chromatograph control apparatus, according to claim 1, wherein each of the appropriate sequences of solvent mixing ratios stored in the storage means is an appropriate sequence of the mixing ratio index values obtained with said preset solvent mixing ratio (solvent concentration) of thin layer chromatography as 1.

19. A liquid chromatograph control method comprising the steps of
performing thin layer chromatography on respective samples at a preset solvent mixing ratio for obtaining plural discrete Rf values;
obtaining the appropriate sequences of solvent mixing ratios of liquid chromatography for the respective samples; and
storing the correspondence relationship between the plural discrete Rf values obtained by thin layer chromatography performed on respective samples at a preset solvent mixing ratio and the appropriate sequences of solvent mixing ratios of liquid chromatography in a storage device;
wherein the step of performing thin layer chromatography on a desired sample to obtain an Rf value before performing liquid chromatography on the sample; the step of obtaining, by interpolation, the appropriate sequence of solvent mixing ratios corresponding to the obtained Rf value from the respective appropriate sequences of solvent mixing ratios of the Rf values on both sides of the obtained Rf value and adjacent to each other stored in the storage device; and performing liquid chromatography according to the obtained appropriate sequence of solvent mixing ratios.

20. A liquid chromatograph control method, according to claim 19, further comprising the step of obtaining the Rf values of thin layer chromatography from the images of the thin layer plates obtained by an imaging device.

21. A liquid chromatograph control method, comprising the steps of:
performing thin layer chromatography on the respective samples respectively containing plural components at a preset solvent mixing ratio to obtain Rf values and the degrees of separation between developed plural components;
performing liquid chromatography for obtaining the appropriate sequences of solvent mixing ratios of liquid chromatography for the respective samples, for the respective degrees of separation between developed plural components, and
storing the correspondence relationships between the plural discrete Rf values obtained by thin layer chromatography performed on respective samples at a preset solvent mixing ratio and the appropriate sequences of solvent mixing ratios of liquid chromatography in a storage device with the separation degree between any two adjacent components of the developed plural components as a parameter;
wherein the step of performing thin layer chromatography on a desired sample to obtain an Rf value and the separation degree between any two adjacent components of the developed plural components before performing liquid chromatography on the sample; the step of selecting a correspondence relationship stored in the storage means in reference to the obtained degree of separation; the step of obtaining, by interpolation, the appropriate sequence of solvent mixing ratios from the respective appropriate sequences of solvent mixing ratios of the Rf values on both sides of the obtained Rf value and adjacent to each other in the selected correspondence relationship; and the step of performing liquid chromatography according to the obtained appropriate sequence of solvent mixing ratios.

22. A liquid chromatograph control method, comprising the steps of:
performing thin layer chromatography on respective samples respectively containing plural components at a preset solvent mixing ratio to obtain Rf values and degrees of separation between developed plural components;
performing liquid chromatography to obtain the appropriate sequences of solvent mixing ratios of liquid chromatography for the respective samples of each Rf values, for the respective degrees of separation between developed plural components;
obtaining the correction factor values corresponding to the respective degrees of separation for correcting the correspondence relationship in reference to the correspondence relationship for a certain degree of separation, and
storing them in a storage device;
wherein the step of performing thin layer chromatography on a desired sample to obtain an Rf value and the separation degree between any two adjacent components of the developed plural components before performing the liquid chromatography on the sample; the step of reading the respective appropriate sequences of solvent mixing ratios of the Rf values on both sides of the obtained Rf value and adjacent to each other and the respective correction factor values from the storage means; the step of correcting the respective appropriate sequences of solvent mixing ratios by the correction factor values, and obtaining, by interpolation, the appropriate sequence of solvent mixing ratios corresponding to the obtained Rf value from the corrected appropriate sequences of solvent mixing ratios of the adjacent Rf values; and the step of performing liquid chromatography according to the obtained appropriate sequence of solvent mixing ratios.

23. A liquid chromatograph control method, according to claim 21, wherein the Rf values of thin layer chromatography and the degrees of separation between developed plural components are obtained from the images of thin layer plates obtained by an imaging means.

24. A liquid chromatograph control method, according to claim 22, wherein the Rf values of thin layer chromatography and the degrees of separation between developed plural components are obtained from the images of thin layer plates obtained by an imaging means.

25. A liquid chromatograph control method, according to claim 21, wherein the degree of separation as a parameter is expressed with the distance between adjacent components as an indicator.

26. A liquid chromatograph control method, according to claim 22, wherein the degree of separation as a parameter is expressed with the distance between adjacent components as an indicator.

27. A liquid chromatograph control method, according to claim 21, wherein the degree of separation as a parameter is expressed with the difference between the inverse numbers of the Rf values of adjacent components as an indicator.

28. A liquid chromatograph control method, according to claim 22, wherein the degree of separation as a parameter is expressed with the difference between the inverse numbers of the Rf values of adjacent components as an indicator.

29. A liquid chromatograph control method, according to claim 21, wherein the degree of separation as a parameter is expressed with the quotient of the Rf values of the substances corresponding to adjacent components as an indicator.

30. A liquid chromatograph control method, according to claim 22, wherein the degree of separation as a parameter is expressed with the quotient of the Rf values of the substances corresponding to adjacent components as an indicator.

31. A liquid chromatograph control method, according to claim 19, wherein the correspondence relationships are obtained for respective types of columns and are stored to allow selection for each type of columns.

32. A liquid chromatograph control method, according to claim 21, wherein the correspondence relationships are obtained for respective types of columns and are stored to allow selection for each type of columns.

33. A liquid chromatograph control method, according to the correspondence relationships are obtained for respective types of columns and are stored to allow selection for each type of columns.

34. A liquid chromatograph control method, according to claim 19, wherein the correspondence relationships are obtained for respective solvents and are stored to allow selection for each solvent.

35. A liquid chromatograph control method, according to claim 21, wherein the correspondence relationships are obtained for respective solvents and are stored to allow selection for each solvent.

36. A liquid chromatograph control method, according to claim 22, wherein the correspondence relationships are obtained for respective solvents and are stored to allow selection for each solvent.

37. A liquid chromatograph control method, according to claim 19, wherein each of the correspondence relationships stored in the storage means is the direct relationship between Rf values and appropriate sequences of solvent mixing ratios.

38. A liquid chromatograph control method, according to claim 21, wherein each of the correspondence relationships stored in the storage means is the direct relationship between Rf values and appropriate sequences of solvent mixing ratios.

39. A liquid chromatograph control method, according to claim 22, wherein each of the correspondence relationships stored in the storage means is the direct relationship between Rf values and appropriate sequences of solvent mixing ratios.

40. A liquid chromatograph control method, according to claim 19, wherein each of the correspondence relationships stored in the storage means is a correspondence relationship between the function values of Rf values and appropriate sequences of solvent mixing ratios.

41. A liquid chromatograph control method, according to claim 21, wherein each of the correspondence relationships stored in the storage means is a correspondence relationship between the function values of Rf values and appropriate sequences of solvent mixing ratios.

42. A liquid chromatograph control method, according to claim 22, wherein each of the correspondence relationships stored in the storage means is a correspondence relationship between the function values of Rf values and appropriate sequences of solvent mixing ratios.

43. A liquid chromatograph control method, according to claim 40, wherein the function values of Rf values are the inverse numbers of Rf values.

44. A liquid chromatograph control method, according to claim 41, wherein the function values of Rf values are the inverse numbers of Rf values.

45. A liquid chromatograph control method, according to claim 42, wherein the function values of Rf values are the inverse numbers of Rf values.

46. A liquid chromatograph control method, according to claim 19, wherein the appropriate sequences of solvent mixing ratios stored in the storage means are appropriate time sequences of solvent mixing ratios.

47. A liquid chromatograph control method, according to claim 21, wherein the appropriate sequences of solvent mixing ratios stored in the storage means are appropriate time sequences of solvent mixing ratios.

48. A liquid chromatograph control method, according to claim 22, wherein the appropriate sequences of solvent mixing ratios stored in the storage means are appropriate time sequences of solvent mixing ratios.

49. A liquid chromatograph control method, according to claim 19, wherein each of the appropriate sequences of solvent mixing ratios stored in the storage means is an appropriate sequence of the mixing ratio index values obtained with said preset solvent mixing ratio (solvent concentration) of thin layer chromatography as 1.

50. A liquid chromatograph control method, according to claim 21, wherein each of the appropriate sequences of solvent mixing ratios stored in the storage means is an appropriate sequence of the mixing ratio index values obtained with said preset solvent mixing ratio (solvent concentration) of thin layer chromatography as 1.

51. A liquid chromatograph control method, according to claim 22, wherein each of the appropriate sequences of solvent mixing ratios stored in the storage means is an appropriate sequence of the mixing ratio index values obtained with said preset solvent mixing ratio (solvent concentration) of thin layer chromatography as 1.

52. A liquid chromatograph control apparatus, according to claim 4, wherein the selection device is a manual selection device for manually selecting a correspondence relationship stored in the storage device in reference to the separation degree between the corresponding two adjacent components of the plural components.

53. A liquid chromatograph control apparatus, according to claim 5, wherein the selection device is an automatic selection device for automatically selecting a correspondence relationship stored in the storage device in reference to the separation degree between the corresponding two adjacent components of the plural components.

54. A liquid chromatograph control apparatus, according to claim 4, wherein the degree of separation is expressed with the distance between adjacent components as an indicator.

55. A liquid chromatograph control apparatus, according to claim 5, wherein the degree of separation is expressed with the distance between adjacent components as an indicator.

56. A liquid chromatograph control apparatus, according to claims 8, wherein the degree of separation is expressed with the distance between adjacent components as an indicator.

57. A liquid chromatograph control apparatus, according to claim 4, wherein the degree of separation is expressed with the difference between the inverse numbers of the Rf values of adjacent components as an indicator.

58. A liquid chromatograph control apparatus, according to claim 5, wherein the degree of separation is expressed with the difference between the inverse numbers of the Rf values of adjacent components as an indicator.

59. A liquid chromatograph control apparatus, according to claim 8, wherein the degree of separation is expressed with the difference between the inverse numbers of the Rf values of adjacent components as an indicator.

60. A liquid chromatograph control apparatus, according to claim 4, wherein the degree of separation is expressed with the quotient of the Rf values of the substances corresponding to adjacent components as an indicator.

61. A liquid chromatograph control apparatus, according to claim 5, wherein the degree of separation is expressed with the quotient of the Rf values of the substances corresponding to adjacent components as an indicator.

62. A liquid chromatograph control apparatus, according to claim 8, wherein the degree of separation is expressed with the quotient of the Rf values of the substances corresponding to adjacent components as an indicator.

63. A liquid chromatograph control apparatus, according to claim 2, wherein the correspondence relationships are obtained for respective types of columns and are stored to allow selection for each type of columns

64. A liquid chromatograph control apparatus, according to claim 3, wherein the correspondence relationships are obtained for respective types of columns and are stored to allow selection for each type of columns.

65. A liquid chromatograph control apparatus, according to claim 4, wherein the correspondence relationships are obtained for respective types of columns and are stored to allow selection for each type of columns.

66. A liquid chromatograph control apparatus, according to claim 5, wherein the correspondence relationships are obtained for respective types of columns and are stored to allow selection for each type of columns.

67. A liquid chromatograph control apparatus, according to claim 8, wherein the correspondence relationships are obtained for respective types of columns and are stored to allow selection for each type of columns.

68. A liquid chromatograph control apparatus, according to claim 2, wherein the correspondence relationships are obtained for respective solvents and are stored to allow selection for each solvent.

69. A liquid chromatograph control apparatus, according to claim 3, wherein the correspondence relationships are obtained for respective solvents and are stored to allow selection for each solvent.

70. A liquid chromatograph control apparatus, according to claim 4, wherein the correspondence relationships are obtained for respective solvents and are stored to allow selection for each solvent.

71. A liquid chromatograph control apparatus, according to claim 5, wherein the correspondence relationships are obtained for respective solvents and are stored to allow selection for each solvent.

72. A liquid chromatograph control apparatus, according to claim 8, wherein the correspondence relationships are obtained for respective solvents and are stored to allow selection for each solvent.

73. A liquid chromatograph control apparatus, according to claim 2, wherein each of the correspondence relationships stored in the storage means is the direct relationship between Rf values and appropriate sequences of solvent mixing ratios.

74. A liquid chromatograph control apparatus, according to claim 3, wherein each of the correspondence relationships stored in the storage means is the direct relationship between Rf values and appropriate sequences of solvent mixing ratios.

75. A liquid chromatograph control apparatus, according to claim 4, wherein each of the correspondence relationships stored in the storage means is the direct relationship between Rf values and appropriate sequences of solvent mixing ratios.

76. A liquid chromatograph control apparatus, according to claim 5, wherein each of the correspondence relationships stored in the storage means is the direct relationship between Rf values and appropriate sequences of solvent mixing ratios.

77. A liquid chromatograph control apparatus, according to claim 8, wherein each of the correspondence relationships stored in the storage means is the direct relationship between Rf values and appropriate sequences of solvent mixing ratios.

78. A liquid chromatograph control apparatus, according to claim 2, wherein each of the correspondence relationships stored in the storage means is a correspondence relationship between the function values of Rf values and appropriate sequences of solvent mixing ratios.

79. A liquid chromatograph control apparatus, according to claim 3, wherein each of the correspondence relationships stored in the storage means is a correspondence relationship between the function values of Rf values and appropriate sequences of solvent mixing ratios.

80. A liquid chromatograph control apparatus, according to claim 4, wherein each of the correspondence relationships stored in the storage means is a correspondence relationship between the function values of Rf values and appropriate sequences of solvent mixing ratios.

81. A liquid chromatograph control apparatus, according to claim 5, wherein each of the correspondence relationships stored in the storage means is a correspondence relationship between the function values of Rf values and appropriate sequences of solvent mixing ratios.

82. A liquid chromatograph control apparatus, according to claim 8, wherein each of the correspondence relationships stored in the storage means is a correspondence relationship between the function values of Rf values and appropriate sequences of solvent mixing ratios.

83. A liquid chromatograph control apparatus, according to claim 2, wherein the appropriate sequences of solvent mixing ratios stored in the storage means are appropriate time sequences of solvent mixing ratios.

84. A liquid chromatograph control apparatus, according to claim 3, wherein the appropriate sequences of solvent mixing ratios stored in the storage means are appropriate time sequences of solvent mixing ratios.

85. A liquid chromatograph control apparatus, according to claim 4, wherein the appropriate sequences of solvent mixing ratios stored in the storage means are appropriate time sequences of solvent mixing ratios.

86. A liquid chromatograph control apparatus, according to claim 5, wherein the appropriate sequences of solvent mixing ratios stored in the storage means are appropriate time sequences of solvent mixing ratios.

87. A liquid chromatograph control apparatus, according to claim 8, wherein the appropriate sequences of solvent mixing ratios stored in the storage means are appropriate time sequences of solvent mixing ratios.

88. A liquid chromatograph control apparatus, according to claim 2, wherein each of the appropriate sequences of solvent mixing ratios stored in the storage means is an appropriate sequence of the mixing ratio index values obtained with said preset solvent mixing ratio (solvent concentration) of thin layer chromatography as 1.

89. A liquid chromatograph control apparatus, according to claim 3, wherein each of the appropriate sequences of solvent mixing ratios stored in the storage means is an appropriate sequence of the mixing ratio index values obtained with said preset solvent mixing ratio (solvent concentration) of thin layer chromatography as 1.

90. A liquid chromatograph control apparatus, according to claim 4, wherein each of the appropriate sequences of solvent mixing ratios stored in the storage means is an appropriate sequence of the mixing ratio index values obtained with said preset solvent mixing ratio (solvent concentration) of thin layer chromatography as 1.

91. A liquid chromatograph control apparatus, according to claim 5, wherein each of the appropriate sequences of solvent mixing ratios stored in the storage means is an appropriate sequence of the mixing ratio index values obtained with said preset solvent mixing ratio (solvent concentration) of thin layer chromatography as 1.

92. A liquid chromatograph control apparatus, according to claim 8, wherein each of the appropriate sequences of solvent mixing ratios stored in the storage means is an appropriate sequence of the mixing ratio index values obtained with said preset solvent mixing ratio (solvent concentration) of thin layer chromatography as 1.
